(19) United States
(12) Patent Application Publication
(10) Pub. No.: US 2026/0287389 A1
(43) Pub. Date: Sep. 24, 2026

(54) METHOD FOR NAVIGATING A VEHICLE DURING AN OFF-ROAD JOURNEY

(71) Applicant: MERCEDES-BENZ GROUP AG, Stuttgart (DE)

(72) Inventor: Joerg KNEIP, Graz (AT)

(21) Appl. No.: 19/471,879

(22) PCT Filed: Mar. 7, 2024
(86) PCT No.: PCT/EP2024/056104

§ 371 Date: Oct. 2, 2025

(30) Foreign Application Priority Data
Apr. 3, 2023 (DE) 10 2023 001 314.5

(51) Int. Cl. G01C 21/00; G01C 21/20

(52) U.S. Cl. CPC G01C 21/3811; G01C 21/20; G01C 21/3844

(57) ABSTRACT

An augmented display is used for navigating a vehicle during off-road journey. While driving over a terrain, a waypoint route having a number of waypoints is produced with respect to a route section travelled by a vehicle, at least based on captured satellite-based geolocation data of the vehicle. The produced waypoint route is transmitted to a central processing unit coupled to the vehicle for data transmission and is provided to further vehicles. During subsequent driving over the terrain by a further vehicle with activated navigation, the determined waypoint route is displayed at least partially overlaid on a captured real environment of the vehicle using successive portals to be driven through by the vehicle.

### BACKGROUND AND SUMMARY OF THE INVENTION

Exemplary embodiments of the invention relate to a method for navigating a vehicle during an off-road journey by means of augmented display, wherein when driving over a terrain, a waypoint route comprising a plurality of waypoints is produced with respect to a route section travelled by a vehicle, at least based on captured satellite-based geolocation data of the vehicle.

DE 10 2020 004 551 A1 discloses a method for supplying data and/or information for off-road journeys of a vehicle, in which method the environment of the vehicle is captured. In addition, the data and/or information is displayed in a real vehicle in an augmented display by means of a virtual vehicle driving ahead of the real vehicle by superimposing the virtual vehicle on a current display of the environment.

EP 1 519 152 A1 describes a device and method for displaying navigation instructions on a projection surface in a vehicle. The device comprises a navigation system, which continually determines position data for the vehicle by means of a satellite-based system and produces the navigation instructions, determined by the navigation system, in an image of the vehicle environment by means of an image production unit. The reliability of the position data is determined. The image production unit produces the navigation instructions in different displays, in accordance with the level of reliability.

Exemplary embodiments of the invention are directed to a novel method for the augmented display of data and/or information relating to navigation of a vehicle during an off-road journey.

A method for navigating a vehicle during an off-road journey by means of augmented display provides that when driving over a terrain, a waypoint route comprising a plurality of waypoints is produced with respect to a route section travelled by a vehicle, at least based on captured satellite-based geolocation data of the vehicle. According to the invention, the produced waypoint route is transmitted to a central processing unit coupled to the vehicle for data transmission and is provided to further vehicles. Moreover, during subsequent driving over the terrain by a further vehicle with activated navigation, the determined waypoint route is displayed at least partially overlaid on a captured real environment of the vehicle by means of successive portals to be driven through by the vehicle.

In particular, the vehicles are assigned to a vehicle fleet and coupled to the central processing unit for data transmission so that the driving over of the route section and vehicle settings, vehicle data and further dynamic driving data set on the route section can be captured at regular intervals of time, saved in the vehicle, and/or transmitted to the central processing unit.

By employing the method, the waypoints are displayed by means of portals, so that the display of route information, in particular in the case of comparatively inaccurate geolocation data, follows a relatively robust concept. By means of the portals, navigation takes place in terrain without roads. In this case, the portals act as an orientation aid comprising a constant display of a direction in which the further vehicle has to drive.

In one embodiment of the method, each determined waypoint of the waypoint route is displayed by means of a portal. In particular, a respective waypoint is based on captured geolocation data captured at regular time and/or spatial intervals, so that a sequence of portals can be created.

In a further embodiment, the individual portals marking the waypoint route, or the waypoint route, are displayed by means of the portals as a function of an uncertainty factor determined based on a determined frequency of capturing at least the geolocation data. That is to say, the individual portals of the waypoint route can be displayed differently in accordance with the determined uncertainty factor or all portals of the waypoint route are displayed in accordance with the determined uncertainty factor.

In one possible embodiment, a width of the respective portal varies as a function of the uncertainty factor, so that for a driver of the further vehicle it is obvious depending on the width that there may be inaccuracies and, for this reason, more attention should be paid to navigating the route section.

To this end, one refinement of the method provides that the respective portal is displayed wider for an uncertainty factor determined to be high than for an uncertainty factor determined to be low. At the least, the more geolocation data about the route section there is, the more accurate is the display of the route section by means of the waypoint route, in particular by means of the portals. In other words: the more often the route section in the terrain is travelled, the more geolocation data is available and the more accurate a specification can be for navigating by means of the portals characterizing the waypoint route.

In one possible refinement, a magnitude of the uncertainty factor varies as a function of an accuracy of at least the captured geolocation data. As described above, the specification of the navigation is more accurate, the more geolocation data there is available, so that in the case of a plurality of geolocation data about the route section being available, the uncertainty factor is also correspondingly low. If this route section has only been driven on and recorded a single time, then the uncertainty factor is at its highest.

In one embodiment, the display of the successive portals varies as a function of a change in a ground surface. That means that when transitioning from stones to rubble or to water, a portal color can change, and the type of ground surface can be assigned a color. For example, water can be represented by means of the color blue and stones by means of grey, so that the portals along the route section are characterized in accordance with the respective ground surface.

In one embodiment, the successive portals are displayed as a function of vehicle settings set during a previous recording of the route section. Here, the display of the portals can vary, for example as a function of respectively set driving programs, an activated differential lock, etc.

Moreover, a further embodiment of the method provides that altitude information about the waypoint route is displayed by means of variance of a transparency of the respective portal. In this case, a tolerance of the altitude information is processed in such a way that the corresponding portal does not rest on a ground surface of the route section with its lower region. The more inaccurate the altitude information is, the more the transparency builds up from the ground surface towards an upper corner of this portal or the portals.

### BRIEF DESCRIPTION OF THE DRAWING FIGURES

Exemplary embodiments of the invention are explained in more detail hereinafter with reference to drawings, in which:

FIG. 1 schematically shows a sequence for determining an uncertainty factor for the augmented display of a waypoint route of a route section by means of a number of portals, and

FIG. 2 schematically shows a view from a vehicle of a route section up ahead, which is partially overlaid by means of portals displayed in augmented fashion.

Mutually corresponding parts are given the same reference numerals in all of the figures.

### DETAILED DESCRIPTION

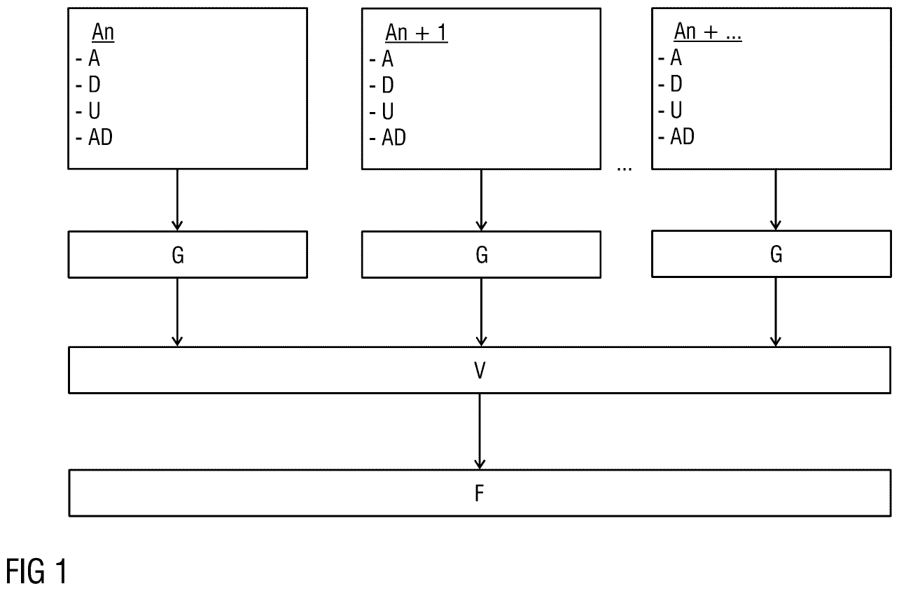

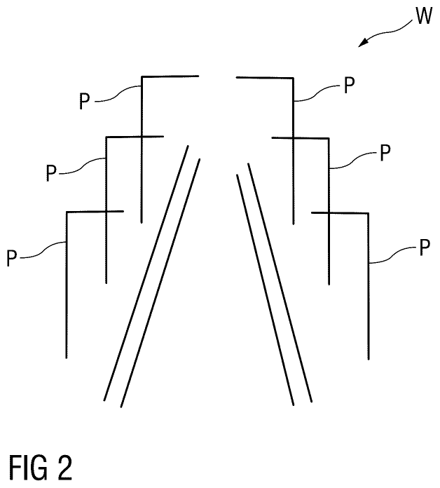

FIG. 1 shows a sequence for determining an uncertainty factor F for the augmented display by means of a number of portals P of a waypoint route W of a route section shown in FIG. 2.

FIG. 2 shows a view from a vehicle when driving over a route section in a terrain, wherein the route section is displayed in augmented fashion by means of portals P characterizing the waypoint route W.

In particular, navigation of a vehicle during an off-road journey by means of augmented display of the route section is described hereinafter.

When navigating terrain without roads, increased demands are placed on navigation and a display of navigation elements. For example, due to a lack of roads and paths, there is an orientation aid, so that a continual display of a direction in which the vehicle is to travel is required. A comparatively accurate waypoint navigation can sometimes only be recorded by a vehicle that is driving over the terrain, in particular a vehicle which belongs to a vehicle fleet and is coupled to a central processing unit for data transmission, and provided, in particular made available, to further vehicles in the vehicle fleet by means of the central processing unit.

Moreover, there is a need to display the route section with a specified degree of inaccuracy, in particular because of geolocation data that is often inaccurate in comparison, for example with respect to altitude information, wherein the geolocation data are received from the respective vehicle in the vehicle fleet at regular time intervals. As a result, a driver of a vehicle driving over the route section cannot be completely absolved of the need to specify a direction.

The method therefore provides for taking the inaccuracy of a waypoint route into consideration by means of various metrics and using it in a display for navigating a vehicle in a terrain. The display for navigating of the vehicle is based in this case on an augmented display, in particular by means of a head-up display unit or in the form of a video based on augmented reality.

Generally, a driver of a vehicle in the vehicle fleet is in possession of a smartphone that is connected to the vehicle wirelessly or via a cable for data exchange. Routes, videos, telemetry data, etc. can thus be sent and received.

It is also possible to use the smartphone to plan a travel route and edit routes or route sections.

The routes or route sections etc. can be shared with drivers of other vehicles in the vehicle fleet, wherein to this end, groups of interested parties can also be created. To this end it is possible, for example, to create so-called stories with images, videos and descriptive texts for a route or a route section and share them on social networks.

In a further embodiment, a service offered by means of the central processing unit can be used for creating, editing and sharing information relating to the vehicle, for example.

Particularly during an off-road journey with a vehicle, the display based on augmented-reality is an efficient way of navigating a waypoint route in the absence of roads and paths.

If the vehicle is located in terrain without roads and paths, for example in a desert or in another rough-terrain environment, the route section is recorded exclusively via satellite-based geolocation data. In this case, tolerances can occur due to the following factors:
general tolerances of a satellite system, for example with respect to a number of satellites, a position and orientation in relation to a recipient vehicle, etc.
a vehicle-internal receiver for satellite signals, i.e., geolocation data, in particular when the route section is recorded by means of a vehicle,
a frequency of generation of data points, i.e., waypoints, while recording,
algorithmic correction procedures in the case of comparatively poor reception of the geolocation data and/or processing of additional vehicle data, for example a wheel impulse.

The total tolerance determined based on this with respect to a waypoint route determined based on the geolocation data can be 1 meters to 2 meters, while altitude information may deviate significantly more.

When a route section is recorded by means of a vehicle, a waypoint route W is determined based on waypoints, that is to say based on the geolocation data, which can be used by a vehicle of the vehicle fleet to drive along the route section again. For this, the waypoint route W is made available to further vehicles in the vehicle fleet by means of the central processing unit. For example, these vehicles in the vehicle fleet belong to a so-called off-road community.

If the terrain is a desert, a track of a vehicle will no longer be visible after a day at the most, meaning that a following vehicle can then only use the waypoints in the form of the waypoint route W, with the geolocation data used to produce the waypoints and the waypoint route W being inaccurate, as described above.

However, an accuracy of the waypoint route W can be increased by repeatedly driving the route section and a computing and averaging the geolocation data. To this end, it is provided to specify the increased accuracy by specifying an uncertainty factor F and saving it for use in a navigation system.

To determine the uncertainty factor F, as is shown in FIG. 1, it is provided that for all recordings An, An+1, An+ . . . of the route section an age A is determined by means of the geolocation data stored in the central processing unit, a data source D, for example a route portal of the central processing unit, is determined, an expected inaccuracy U, for example with respect to a measuring method, is determined, and a comparison AD with global data, for example satellite images, is carried out.

This information is subsequently weighted, wherein a mathematical calculation V of a weighted sum of the information is carried out and an uncertainty factor F is produced for each data point, i.e., waypoint.

The waypoint route W is then produced with x, y, and z coordinates and with the uncertainty factor F for each waypoint and an uncertainty factor F for the waypoint route W.

If only one journey has been made for this route section, the inaccuracy factor F is at its highest. Providing an uncertainty factor F per waypoint or waypoint route W, for example via a server service of the central processing unit, can expediently change the display of the navigation.

The following information about a route section is only available to an inaccurate degree without reference to road or map data:
a spatial position, in particular a piece of altitude information due to tolerances that occur when the route section is recorded as the original route, and
a relation between a waypoint determined based on the geolocation and a current position of the vehicle driving behind, which can likewise be affected by tolerances.

The more inaccurate the geolocation data of the vehicle when the route section is being driven over, the more robust the display of route information for the navigation of a further vehicle driving over the route section needs to be.

To this end, it is provided to display the individual waypoints of the waypoint route W by means of portals P in augmented fashion, wherein the higher the determined uncertainty factor F, the wider the respective portal P is displayed.

With respect to the display of the altitude information, the tolerance thereof is processed in such a way that the respective portal P does not rest on the ground surface with its lower region. The more inaccurate the altitude information is, the more transparent the portal P is displayed in augmented fashion from the direction of the ground surface towards upper corner regions.

In accordance with FIG. 2, a route section was driven on in a desert and recorded. When the route section is subsequently driven on, this is displayed in the vehicle in augmented fashion as a waypoint route W by means of the portals P.

The more often the route section is driven on, the more information, in particular geolocation data, there is available and the more accurate the navigation of the respective vehicle driving over the route section can be by means of the portals P displayed in augmented fashion.

In this case it is possible, by means of the portals P, for example based on the color, width, thickness, structure, transparency, etc. thereof, to display further information to the driver of the vehicle driving over the route section.

For example, changing the color of the portals P can be used to indicate that a ground surface of the route section has changed. If the vehicle is driving through water, the portals P located in this area and characterizing the respective waypoint are be shown in blue. If the vehicle is driving over an area with rubble and/or stones, these portals assigned to the area can be shown in grey and/or brown.

The portals P characterizing the waypoint W can also be used to display vehicle settings that were set when a further vehicle drove over the route section previously. For example, a color can be used to indicate which driving program was set and/or whether a differential lock was engaged, etc.

Moreover, in one embodiment, a corresponding display of the portals P can be used to indicate whether vehicle data captured when recording the route section reached certain vehicle telemetry values, for example minimum values or maximum values. For example, suspension travel measured by means of a level sensor system can be displayed.

Alternatively or additionally, speed differences in relation to previous travel over the route section can be displayed using the portals P displayed in augmented fashion for navigating the vehicle. For example, a portal P can be displayed in green when the route section is being driven over faster by the vehicle than during a previous journey.

When the driver of the vehicle driving over the route section selects the wrong direction of travel, a nearby portal P can be displayed in red to make the driver of the vehicle aware of the wrong direction of travel.

In a further embodiment, the portals P characterizing the route W for navigation are displayed with comparatively less visibility when they are far away from the vehicle. Therefore, the distance of the respective portal P from the vehicle can also be indicated by a corresponding characteristic.

Again alternatively or additionally, it can be provided that the characteristics, for example the colors, of the portals P change as a function of a speed of travel of the vehicle. Therefore, the driver can also be notified when the current speed of travel of the vehicle is selected to be too high when a region of the route section is being driven over and there is thus a risk of the vehicle being involved in an accident.

By means of the method, a driver of a vehicle, in particular in special navigation situations, in particular during off-road journeys, can be receive information in a targeted manner by an adapted display of the portals P. In the case of the augmented display of the portals P as navigation elements, the determined uncertainty factor F is taken into consideration, meaning that the driver of the vehicle departing from the route section can be advised to increase their attention and, if necessary, reduce their current speed of travel to reduce the risk of an accident.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method comprising:
traveling, by a first vehicle on off-road terrain, a route section;
producing, based at least one captured satellite-based geolocation data of the first vehicle while traveling over the route section, a waypoint route comprising a plurality of waypoints;
transmitting, by the first vehicle the waypoint route to a central processing unit, the produced waypoint route;
distributing, by the central processing unit, the produced waypoint route to further vehicles, wherein the further vehicles include a second vehicle; and
displaying, by the second vehicle as the second vehicle travels over the route section with activated navigation, the produced waypoint route at least partially overlaid on a captured real environment of the second vehicle using successive portals to be driven through by the second vehicle.

11. The method of claim 10, wherein each of the plurality of waypoint of the waypoint route are displayed as one of the successive portals.

12. The method of claim 10, wherein the successive portals marking the waypoint route or the waypoint route is/are displayed by the successive portals as a function of an uncertainty factor determined based on a determined frequency of capturing at least the geolocation data.

13. The method of claim 12, wherein a width of a respective one of the successive portals varies as a function of the determined uncertainty factor.

14. The method of claim 13, wherein the respective one of the successive portals is displayed wider when the uncertainty factor is determined to be high than for when the uncertainty factor is determined to be low.

15. The method of claim 12, wherein a magnitude of the uncertainty factor varies as a function of an accuracy of at least the geolocation data.

16. The method of claim 12, wherein the displaying of the successive portals is varied as a function of a change in a ground surface below the second vehicle.

17. The method of claim 12, wherein the successive portals are displayed as a function of vehicle settings set during a previous recording of the route section by at least the first vehicle.

18. The method of claim 12, wherein altitude information about the produced waypoint route is displayed by variance of a transparency of a respective one of the successive portals.
